(19) United States
(12) Patent Application Publication
(10) Pub. No.: US 2009/0173843 A1
(43) Pub. Date: Jul. 9, 2009

(54) MOUNTING STRUCTURES FOR WIRE HARNESSES

(75) Inventor: Benjamin Warren Penner, Ann Arbor, MI (US)

Correspondence Address: DINSMORE & SHOHL, LLP, 1900 CHEMED CENTER, 255 EAST FIFTH STREET, CINCINNATI, OH, 45202, US

(73) Assignee: Toyota Motor Engineering & Manufacturing North America, Inc., Erlanger, KY (US)

(21) Appl. No.: 11/971,236

(22) Filed: Jan. 9, 2008

(51) Int. Cl. F16L 3/02; B60K 37/04

(52) U.S. Cl. 248/65; 296/193.02

(57) ABSTRACT

Mounting structures for wire harnesses may include a first finger and a second finger with each finger extending outwardly from a substrate. The first finger and the second finger may form a housing between the first finger, the second finger and the substrate for holding the wire. The first finger and the second finger may be offset from one another along a first axis through the substrate.

### TECHNICAL FIELD

The present invention generally relates to mounting structures for wire harnesses integrated within a vehicle instrument panel.

### BACKGROUND

Mounting structures are used for securing and connecting wire harnesses of vehicle electrical systems, such as those integrated with vehicle instrument panels (IPs). Current vehicles utilize a clip located on the wire harness which is then clipped onto a rib located on the IP. However, such conventional clips are generally unable to secure multiple wire harnesses, especially those of different sizes. Moreover, such conventional clips may became snagged on the vehicle body during installation of the instrument panel into the vehicle thereby causing the wire harness(es) and/or clip to become disengaged from the instrument panel.

Accordingly, improved mounting structures for wire harnesses are desired.

### SUMMARY

According to one embodiment, a mounting structure for a wire may include a first finger and a second finger, each extending outwardly from a substrate. The first finger and the second finger may form a housing between the first finger, the second finger, and the substrate such that a wire may be held in the housing. The first finger and the second finger may be laterally spaced from one another such that the first finger and the second finger do not overlap.

According to another embodiment, a mounting structure for a wire may include a first finger and a second finger extending outwardly from a substrate. The first finger may curve upwardly relative to the second finger and the second finger may curve downwardly relative to the first finger. The first finger and second finger may be laterally spaced from one another. The first finger and the second finger may form a housing for holding a wire between the first finger, the second finger and the substrate.

According to yet another embodiment, a mounting structure for a wire may include a retention feature and a finger extending outwardly from a substrate. The finger may include a holding surface positioned opposite the substrate. The finger may also include an end. The finger may form a housing for holding a wire between the holding surface of the finger and the substrate.

These and additional features can be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. Moreover, the individual features of the drawings will be more fully apparent and understood in view of the detailed description. The following detailed description of specific embodiments described herein can be understood when read in conjunction with the following drawings, where like structure is indicated with like reference numerals and in which:

FIG. 1 is a front view of a mounting structure according to one or more embodiments of the present invention;

FIG. 2 is a front view of a mounting structure according to one or more embodiments of the present invention;

FIG. 3 is a perspective top view of a mounting structure according to one or more embodiments of the present invention;

FIG. 4 is a perspective top view of a mounting structure with a wire harness secured therein according to one or more embodiments of the present invention;

FIG. 5 is a perspective top view of a mounting structure according to one or more embodiments of the present invention;

FIG. 6 is a perspective top view of a mounting structure according to one or more embodiments of the present invention; and

FIG. 7 is a perspective top view of a mounting structure with a wire harness secured therein according to one or more embodiments of the present invention.

### DETAILED DESCRIPTION

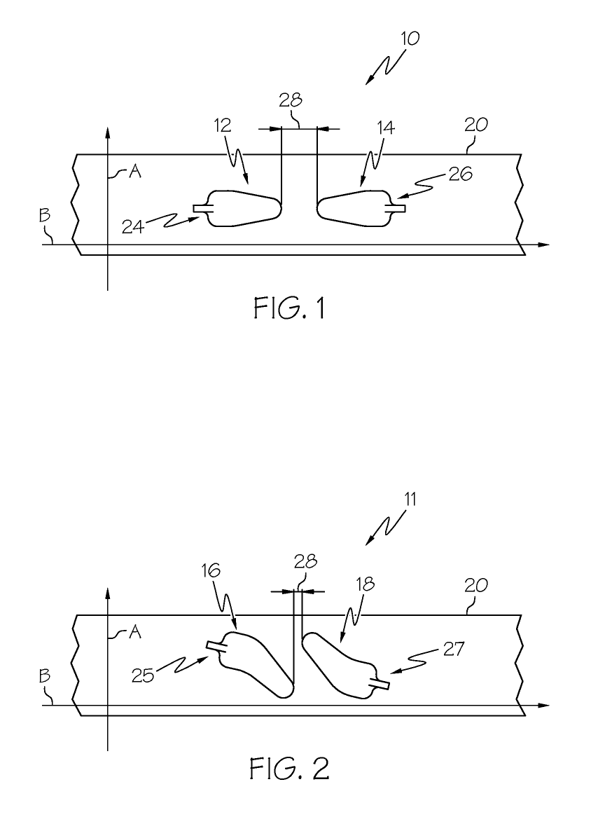

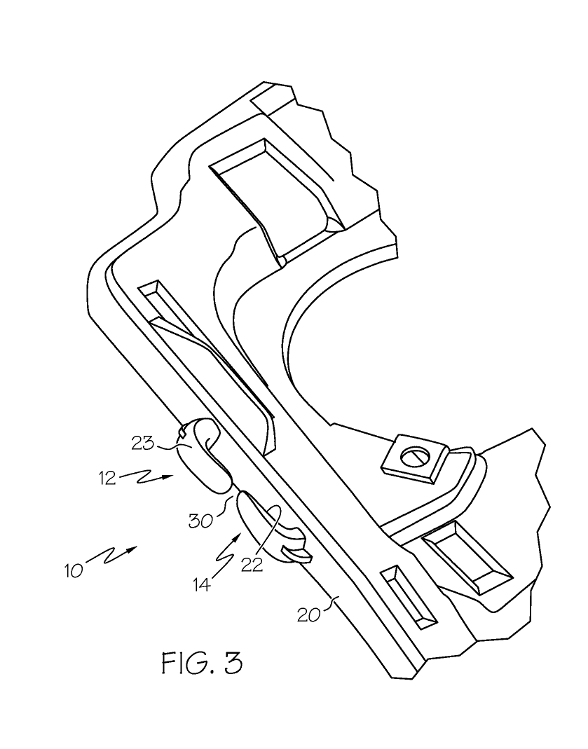

Referring to FIGS. 1, 2, 5 and 6, exemplary mounting structures for wire harnesses are illustrated. Referring to FIGS. 1 and 3, an exemplary mounting structure 10 comprises at least two fingers 12 and 14 secured to a substrate 20. In one embodiment, such as that illustrated in FIGS. 1, 3 and 4, substrate 20 may comprise a portion of a side instrument panel (e.g., a panel concealing the interior portion of a door assembly). However, it should be understood that the mounting structure 10 can be located at any position about a vehicle, including within the front instrument panel (e.g., in front of the driver and passenger seats) in order to secure one or more wires or wire harnesses (collectively and individually, wire harnesses) from any electrical system within the vehicle.

In addition, in one embodiment, fingers 12 and 14 of mounting structure 10 may be comprised of flexible plastic and integrally molded within the instrument panel substrate. Of course, in another embodiment, fingers 12 and 14 and/or mounting structure 10 itself may be comprised of a number of flexible materials with separate components secured to the substrate through adhesives, fasteners and/or a variety of other methods.

As illustrated in FIGS. 1, 3 and 4, the mounting structure 10 may be positioned on the substrate 20 such that finger 12 commences from a first location 24 and finger 14 commences from a second location 26. The first location 24 and second location 26 may be equidistant from the horizontal axis B in the vertical direction A such that the first finger 12 and second finger 14 lay along the same horizontal line parallel to the horizontal axis B. The first finger 12 and second finger 14 may extend outwardly from the substrate 20 such that the first finger 12 is substantially opposed to the second finger 14, as depicted in FIG. 1. It should be understood that fingers 12 and 14 may comprise any length or shape suitable for securing any size or number of wire harnesses.

Still referring to FIGS. 1, 3 and 4, in one embodiment, fingers 12 and 14 may be laterally spaced from one another along horizontal axis B so that fingers 12 and 14 do not effectively overlap. Particularly, mounting structure 10 may be configured so that fingers 12 and 14 do not overlap. In this regard, the fingers 12 and 14 may comprise an effective gap 28 between one another (e.g., in the lateral direction, as shown in FIGS. 1, 3 and 4 and in the lateral and vertical directions as shown in FIG. 2) so that a wire harness can be inserted and removed. However, the gap between the fingers 12 and 14 is not so large such that the wire harness disengages from the mounting structure 10, as discussed below. In another embodiment, the fingers 12 and 14 abut against one another such that the fingers 12 and 14 neither overlap nor have an effective gap disposed there between.

In another embodiment, as depicted in FIG. 2, the mounting structure 11 may comprise fingers 16 and 18 offset from one another along a vertical axis A. Particularly, finger 16 is angled downward, whereas finger 18 is angled upward, hence, each finger generally extends outwardly from the substrate in opposite directions along both the vertical axis A and the horizontal axis B. A wire harness may be inserted within the mounting structure 11 (discussed later herein) and secured thereby preventing the disengagement thereof. In addition, in one embodiment, fingers 16 and 18 may be offset from one another wherein finger 16 may commence at a first location 25 in the vertical axis A and finger 18 may commence at a second location 27 in the vertical axis A. It should be understood that fingers 16 and 18 may comprise any length or shape suitable for securing any size or number of wire harnesses.

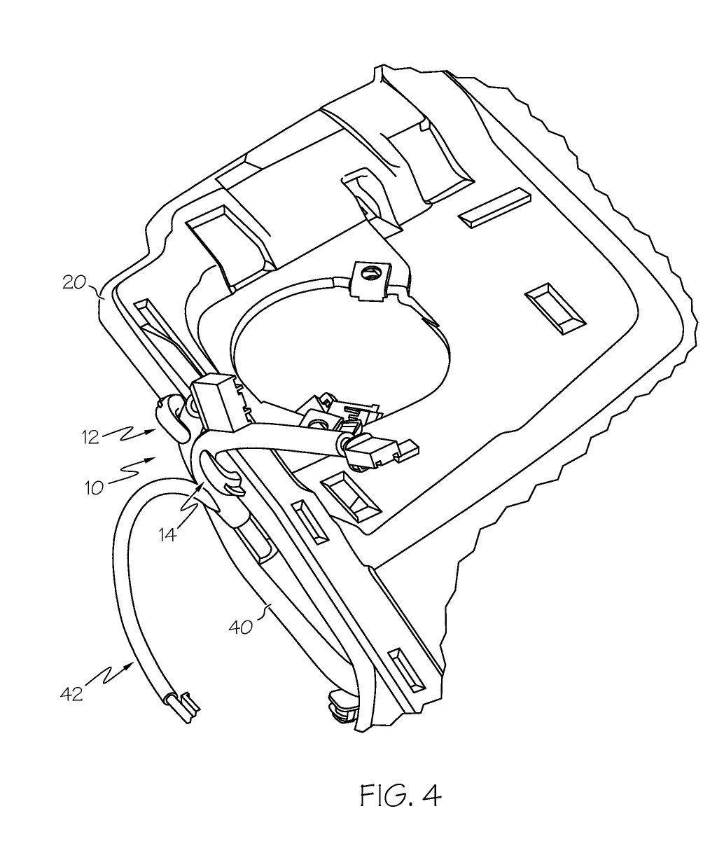

Referring again to FIGS. 1, 3 and 4, in use, a technician may secure one or more wire harnesses 40 and 42 to mounting structure 10. Particularly, wire harnesses 40, 42 can be slid into the mounting structure 10 one by one (or a plurality at one time) by forcing the wire harnesses through the gap 28 between fingers 12 and 14. Fingers 12 and 14 may be particularly shaped and flexible enough to allow a wire harness to be secured within mounting structure, but rigid enough to prevent the disengagement of a secured wire harness without applying significantly more force than required for engagement. In addition, the general outward curvature of the fingers 12 and 14 provides a housing 30 between the fingers 12 and 14 and substrate 20 for holding and protecting the wire harness and preventing the wire harness from becoming snagged and disengaged during vehicle assembly. For example, referring to FIGS. 3-4, once a wire harness is engaged into mounting structure 10 (e.g., FIG. 4), the wire harness 40 is held in the housing 30 formed by the fingers 12 and 14 through contact with the holding surfaces 22 and 23 of fingers 12 and 14, respectively. The continuous contact of the wire harness with at least one of the holding surfaces 22 and 23, which is the result of the shape of the fingers, prevents the wire harness from disengaging the mounting structure 10. If removal of a wire harness from the structure is desired, a technician may pull the harness outwardly against flexible fingers and through gap there between. Accordingly, mounting structures for wire harnesses described herein are capable of securing one or more wire harnesses in a manner that prevents accidental disengagement.

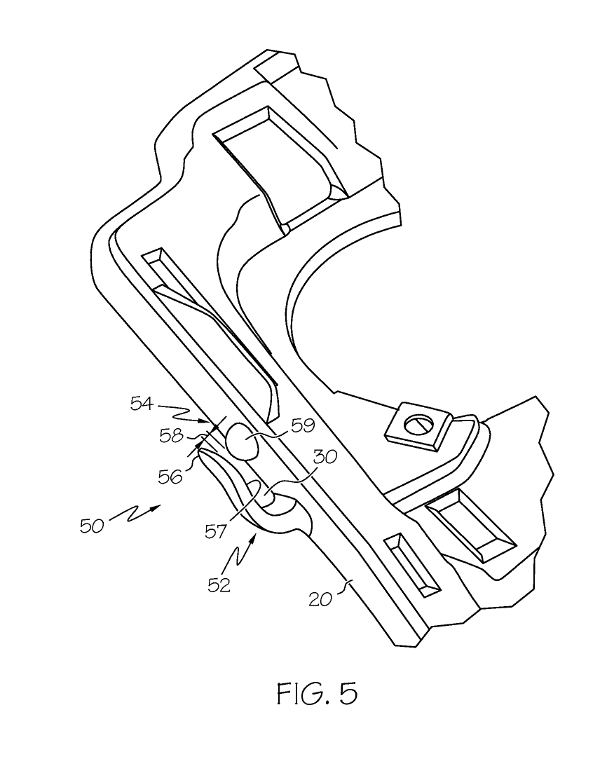

Referring now to FIGS. 5 and 7, in another embodiment, the mounting structure 50 may comprise one finger 52 secured to the substrate 20. The finger 52 may have an end 56 and a holding surface 57. The holding surface 57 may be substantially opposed to the substrate 20. In one embodiment, the end 56 of the finger 52 may be curved outward, away from the substrate 20 as shown in FIG. 5. The finger 52 and substrate 20 together form a housing 30 for holding a wire harness on the substrate 20.

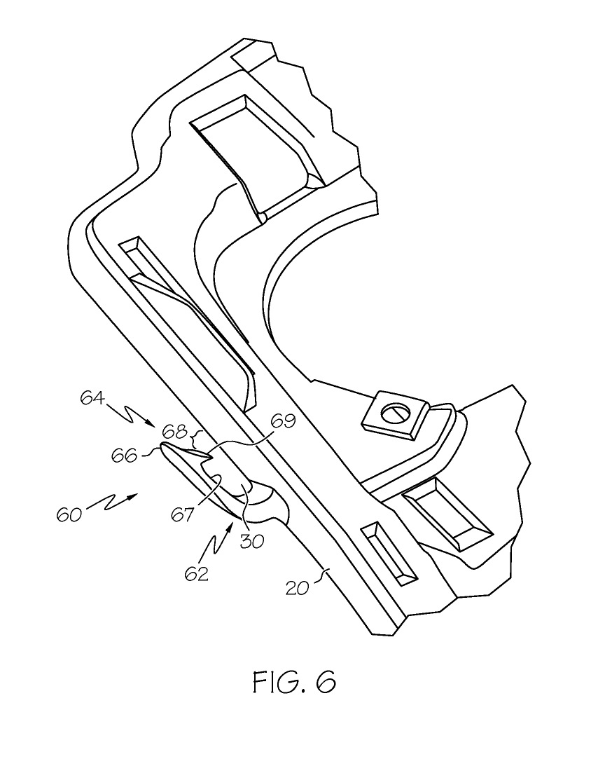

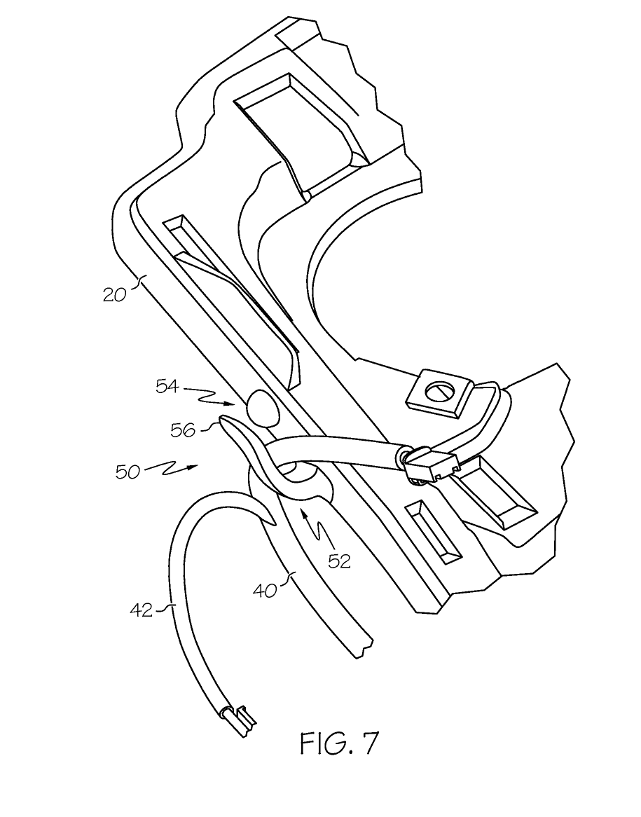

As shown in FIGS. 5 and 7, the mounting structure 50 may also comprise a retention feature. In the embodiment shown in FIGS. 5 and 7, the retention feature is a protrusion 54 extending from the substrate 20. The protrusion 54 may comprise a holding surface 59. The protrusion 54 is positioned on the substrate substantially opposite the end 56 of the finger 52. As depicted in FIGS. 5 and 6, the protrusion 52 may be hemispherical. However, it should be understood that the protrusion 52 may be of any suitable shape for retaining a wire harness in the housing 30. In one embodiment, as shown in FIG. 5, there may be an effective gap 58 between the protrusion 52 and the end 56 of the substrate. The effective gap 58 may be of suitable size and configuration such that a wire harness may be inserted and removed from the mounting structure 50 but not so large that the wire harness may become unintentionally or inadvertently disengaged from the mounting structure 60. In another embodiment, the end 56 of the finger 52 may abut against the protrusion 54 such that there is no effective gap between the protrusion 52 and the finger 52.

Still referring to FIGS. 5 and 7, in use, a technician may slide a wire harness 40 or harnesses 40, 42 into the mounting structure 50 by forcing the wire harness 40 between the protrusion 54 and the finger 52. The finger 52 may be particularly shaped and flexible enough to allow the wire harness 40 to be secured within the housing 30 formed by the mounting structure 50, but rigid enough to prevent the wire harness 40 from becoming disengaged from the mounting structure 50 without the application of significantly more force than required for engagement. When the wire harness 40 is engaged with the mounting structure 50, the protrusion 54 prevents the wire harness 40 from being withdrawn from the mounting structure 50 without the application of force. More particularly, when the wire harness 40 is moved towards the gap 58, the wire harness 40 contacts the holding surface 59 of the protrusion 54 and the holding surface 57 of the finger 52 which prevent the wiring harness 40 from being withdrawn from the housing 30. To withdraw the wiring harness 40 from the housing 30, the gap 58 between the protrusion 54 and the finger 52 must be increased. This may be accomplished by forcibly pulling the wire harness 40 from the housing 30. Alternatively, the gap 58 may be increased by applying a force to the outwardly curved end 56 of the finger 52 thereby pulling the finger 52 away from the protrusion 54 and increasing the gap 58. The wire harness 50 may then be freely withdrawn from the mounting structure 50.

Referring now to FIG. 6, in another embodiment, the mounting structure 60 may comprise one finger 62 secured to the substrate 20. The finger 62 may have an end 66 and a holding surface 67. The holding surface 67 may be substantially opposed to the substrate 20. In one embodiment, the end 66 of the finger 62 may be curved outward, away from the substrate 20 as shown in FIG. 6. The finger 62 and substrate 20 may together form a housing 30 for holding a wire harness to the substrate 20.

In the embodiment shown in FIG. 6, the mounting structure 60 comprises a retention feature. More specifically the retention feature comprises a barb 64 positioned on the end 66 of the finger 62 and extending inward, into the housing 30 and toward the substrate 20. In one embodiment, there may be an effective gap 68 between the barb 64 and the substrate 20 as shown in FIG. 5. The effective gap 68 may be of suitable size and configuration such that a wire harness may be inserted and removed, but not so large that the wire harness may become unintentionally or inadvertently disengaged from the mounting structure 60. In another embodiment, the barb 64 may abut against the substrate 20. The barb 64 may have a holding surface 69 positioned opposite the holding surface 67 of the finger.

Still referring to FIG. 6, in use, a technician may slide a wire harness into the mounting structure 60 by forcing the wire harness between the barb 64 and the substrate 20. The finger 62 may be particularly shaped and flexible enough to allow the wire harness to be secured within the housing 30 formed by the mounting structure 60, but rigid enough to prevent the wire harness from becoming disengaged from the mounting structure 60 without the application of significantly more force than required for engagement. When the wire harness is engaged with the mounting structure 60, the barb 64 prevents the wire harness from being withdrawn from the mounting structure 60. More particularly, when the wire harness is moved back towards the gap 68, the contact surface 69 of the barb 64 contacts the wire harness and prevents the wire harness from passing through the gap 68 without additional manipulation of the finger 62 with respect to the substrate 20. In particular, to release the wire harness from the mounting structure 60, a force must be exerted on the end 66 of the finger 62 to pull the finger 62 away from the substrate 20 thereby increasing the gap 68 between the barb 64 and the substrate 20. The wire harness may then be freely withdrawn from the mounting structure 60.

It should now be apparent that the various embodiments of the mounting structures illustrated and described herein may be used to secure wires and/or wire harnesses to a substrate. The mounting structures will facilitate the attachment of wires and/or wire harnesses to the substrate while simultaneously protecting the wires during assembly operations. While particular reference has been made herein to the use of the mounting structures in conjunction with vehicle instrument panels, it should be apparent that the mounting structures discussed herein may be suitable for use in conjunction with automobiles, aircraft, electronic devices, appliances, and the like.

The foregoing description of the various embodiments has been presented for the purpose of illustration and description. It is not intended to be exhaustive or to limit the invention to the precise forms disclosed. Many alternatives, modifications and variations will be apparent to those skilled in the art. Moreover, although many inventive aspects have been presented, such aspects need not be utilized in combination, and various combinations of inventive aspects are possible in light of the various embodiments provided above. Accordingly, the above description is intended to embrace all possible alternatives, modifications, combinations and variations that have been discussed or suggested herein, as well as others that fall within the principles, spirit, and broad scope of the various inventions as defined by the claims.

What is claimed is:

1. A mounting structure for a wire comprising a first finger and a second finger, each extending outwardly from a substrate, the first and second fingers forming a housing for holding the wire between the first finger, the second finger and the substrate, the first and second fingers being laterally spaced from one another, so that the first and second fingers do not overlap.

2. The mounting structure of claim 1, wherein the first and second fingers are offset from one another along a first axis through the substrate.

3. The mounting structure of claim 2 wherein the first axis is a vertical axis.

4. The mounting structure of claim 1 wherein the mounting structure is secured to a panel of a vehicle.

5. The mounting structure of claim 1 wherein the wire is a part of a wire harness.

6. The mounting structure of claim 1 wherein the first finger is curved upwardly relative to the second finger.

7. The mounting structure of claim 1 wherein the second finger is curved downwardly relative to the first finger.

8. The mounting structure for a wire of claim 1 wherein the first finger and the second finger extend in opposite directions with a gap between the first finger and the second finger such that the first finger and second finger do not overlap.

9. A mounting structure for a wire comprising a first finger and a second finger, each of the first finger and the second finger extending outwardly from a substrate, the first finger curved upwardly relative to the second finger, the second finger curved downwardly relative to the first finger, the first and second fingers forming a housing for holding a wire between the first finger, the second finger and the substrate, the first and second fingers being laterally spaced from one another.

10. The mounting structure of claim 9 wherein the first finger and the second finger are offset from one another along a first axis through the substrate.

11. The mounting structure of claim 10 wherein the first axis is a vertical axis.

12. The mounting structure of claim 9 wherein the first and second fingers are laterally spaced from one another along a horizontal axis through the substrate.

13. The mounting structure of claim 9 wherein the first finger and the second finger do not overlap one another.

14. The mounting structure of claim 9 further comprising a gap between the first and second fingers, so that the first and second fingers do not overlap one another.

15. A mounting structure for a wire comprising a finger extending outwardly from a substrate and a retention feature;
wherein the finger comprises an end and a holding surface positioned opposite the substrate;
wherein the retention feature is disposed between the substrate and the end of the finger; and
wherein the finger forms a housing for holding a wire between the holding surface of the finger and the substrate.

16. The mounting structure of claim 15 wherein the end of the finger is curved away from the substrate.

17. The mounting structure of claim 15 wherein the retention feature comprises a barb extending from the end of the finger such that the barb extends inwardly from the end of the finger into the housing and toward the substrate, the barb having a contact surface opposed to the contact surface of the finger.

18. The mounting structure of claim 15 wherein the retention feature comprises a protrusion extending from the substrate, the protrusion having a holding surface, wherein the protrusion is positioned substantially opposite the end of the finger.

19. The mounting structure of claim 15 wherein the wire is a part of a wire harness.

20. The mounting structure of claim 15 wherein the mounting structure is secured to an instrument panel of a vehicle.
